(19) United States
(12) Patent Application Publication
(10) Pub. No.: US 2010/0114382 A1
(43) Pub. Date: May 6, 2010

(54) Determination of the Type of Heaving, Ventilating, and Air Conditioning (HVAC) System

(75) Inventors: Wai-leung Ha, Wanchai (HK); Kairy Kai Lei, Shen Zhen City (CN); Hao-hui Huang, Shen Zhen City (CN)

Correspondence Address: BANNER & WITCOFF, LTD., TEN SOUTH WACKER DRIVE, SUITE 3000, CHICAGO, IL, 60606, US

(73) Assignee: Computime, Ltd., Wanchai (HK)

(21) Appl. No.: 12/265,304

(22) Filed: Nov. 5, 2008

(51) Int. Cl. G05B 15/00

(52) U.S. Cl. 700/276

(57) ABSTRACT

The present invention provides apparatuses and computer readable media for obtaining information about a heating, ventilating, and air conditioning (HVAC) system and sending the information to a remote networked device. A control circuit deactivates loads of a HVAC system so that a sampling circuit can inject a test signal into the loads. Based on a resulting signal, a processor determines what loads are connected to a thermostat. The processor can consequently determine the type of the HVAC system. The processor may further utilize a lookup table that maps possible values of the resulting signal with different types of HVAC systems. The thermostat may consequently send information about the load configuration to a networked device. The thermostat may further detect a change of the load configuration and notify the networked device and may periodically inject the test signal into the connected loads when the control relays are deactivated.

### BACKGROUND

The smart energy market often utilizes a wireless network to provide metering and energy management. Wireless networking include neighborhood area networks for meters, using wireless networking for sub-metering within a building, home or apartment and using wireless networking to communicate to devices within the home. Different installations and utility preferences often result in different network topologies and operation. However, each network typically operates using the same basic principals to ensure interoperability. Also, smart energy devices within a home may be capable of receiving public pricing information and messages from the metering network. However, these devices may not have or need all the capabilities required to join a smart energy network.

A smart energy network may assume different network types, including a utility private home area network (HAN), a utility private neighborhood area network (NAN), or a customer private HAN. A utility private HAN may include an in-home display or a load control device working in conjunction with an energy service portal (ESP), but typically does not include customer-controlled devices.

A smart energy network may interface with different types of devices including a heating, ventilating, and air conditioning (HVAC) system. With the increasing cost of energy, it is important that a HVAC system operates efficiently and reliably. Consequently, there is a real market need to provide information of different components in a HVAC system through a wireless network.

### SUMMARY

The present invention provides apparatuses and computer readable media for obtaining information about a heating, ventilating, and air conditioning (HVAC) system and sending the information to a remote networked device.

With another aspect of the invention, a control circuit deactivates loads of a HVAC system so that a sampling circuit can inject a test signal into the loads. Based on a resulting signal, a processor determines what loads are connected to a thermostat. The processor can consequently determine the type of the HVAC system.

With another aspect of the invention, the processor may utilize a lookup table that maps possible values of the resulting signal with different types of HVAC systems.

With another aspect of the invention, the thermostat may send information about the load configuration to a networked device. The thermostat may further detect a change of the load configuration and notify the networked device. The thermostat may periodically inject the test signal into the connected loads when the control relays are deactivated.

### BRIEF DESCRIPTION OF THE DRAWINGS

The foregoing summary of the invention, as well as the following detailed description of exemplary embodiments of the invention, is better understood when read in conjunction with the accompanying drawings, which are included by way of example, and not by way of limitation with regard to the claimed invention.

FIG. 1 shows a networked system for obtaining information for a heating, ventilating, and air conditioning (HVAC) system in accordance with an embodiment of the invention.

FIG. 2 shows a networking system with a thermostat that determines a type of HVAC system in accordance with an embodiment of the invention.

FIG. 3 shows a thermostat in accordance with an embodiment of the invention.

FIG. 4 shows a sampling circuit and control circuit in accordance with an embodiment of the invention.

FIG. 5 shows a flow diagram for determining the HVAC type in accordance with an embodiment of the invention.

FIG. 6 shows a lookup table for determining the HVAC type in accordance with an embodiment of the invention.

### DETAILED DESCRIPTION

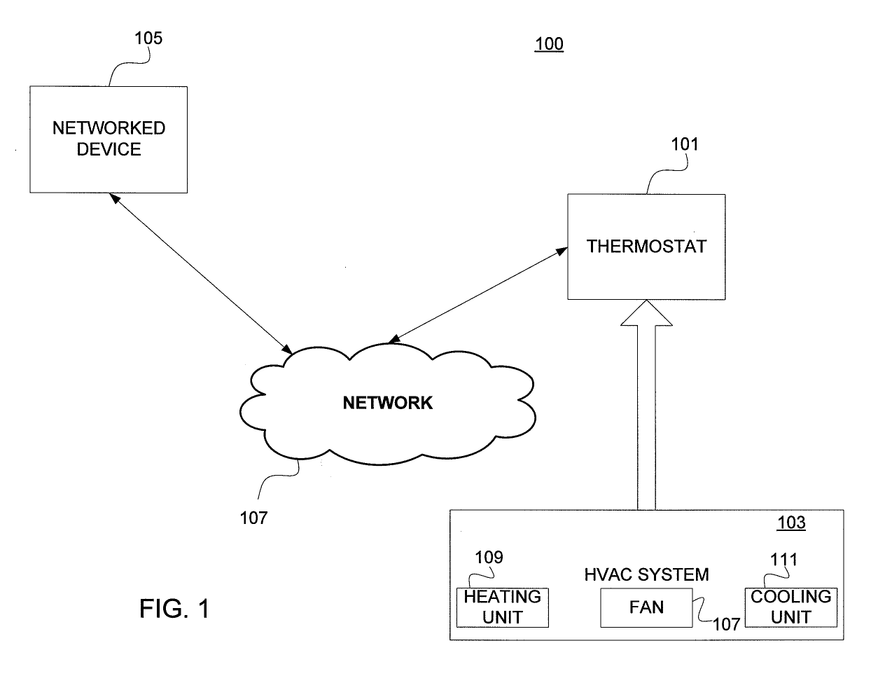

FIG. 1 shows networked system 100 for obtaining information for heating, ventilating, and air conditioning (HVAC) system 103 in accordance with an embodiment of the invention. HVAC system 103 typically includes different HVAC units such as fan 107, heating unit (furnace) 109, and cooling unit (air conditioner) 111. Each HVAC unit may further have different components (not shown). For example, heating unit 109 may include a heat pump reverse valve, second stage heat pump, and emergency heat component. Cooling unit 111 may include a cooling reverse valve, and a cooling component. Each component, as will be discussed, may appear as a load to a controlling unit (e.g., a thermostat 101).

One the typical functions of thermostat 101 is to control HVAC system, e.g., activating cooling unit 111 when the measured temperature is too high or activating hating unit 109 when the measured temperature is too low. In addition, thermostat 101 may provide status information to networked device 105 through network 107. For example, thermostat 101 may provide information to networked device 105 that is indicative of the type of HVAC system. Information about each component in HVAC system 103 may be important in managing and maintaining networked system 100. For example, in a smart energy area, if the HVAC type is gas furnace, there is typically no need for the system to participate in electricity reduction program.

With some embodiments, network 107 supports a wireless protocol, including ZigBee™ or other IEEE 802.15.4 based protocols. Additional embodiments include supporting network protocols using a Wi-Fi® protocol, a Bluetooth® protocol, or using wired connections, such as 10 BASE-T or 100 BASE-T Ethernet.

HVAC information may be provided from thermostat 101 to monitoring device 105 in accordance with a ZigBee smart energy specification, e.g., Smart Energy Profile Specification, ZigBee Standards Organization, May 2008 and ZigBee Cluster Library Specification, ZigBee Standards Organization, May 2008, which are incorporated by reference. However, sending HVAC information from thermostat 101 to monitoring device 101 as manufacturing specific information (customer-defined cluster) in a data container (cluster), which may be conveyed by the payload of a ZigBee Cluster Library (ZCL) frame format, may be difficult to an end user because the specific data format is typically not published and thus not easily available to the end user. HVAC information may be facilitated by including HVAC information in a standard available cluster (publicly accessible cluster).

A smart energy networking system (e.g., system 100) typically includes a gateway, controller (e.g., networked device 105), display, and programmable control thermostat (e.g., thermostat 101). While the controller typically has the ability to configure the thermostat set point, setback, and heat/cool change over control, the controller may utilize information about the type of HVAC system that is connected to the thermostat. A traditional thermostat usually sets the end HVAC system through hard switches configured by an end user. However, with a traditional thermostat design, it may be difficult to determine what type of HVAC system is connected to the thermostat. With embodiments of the invention, the type of HVAC system is automatically determined. Consequently, information may be sent though network 107 from thermostat 101 to networked device 105 using a predefined data structure or encoded data.

There are many type of HVAC system now. Exemplary HVAC types include:
Basic Heat
Basic Cool
Separated heat/cool system but connected to one thermostat
Heat Pump with Heat/Cool
Heat Pump with two stages heat and one cool
Heat Pump with two stages heat and two stages cool
Heat Pump with three stages heat and two stages cool

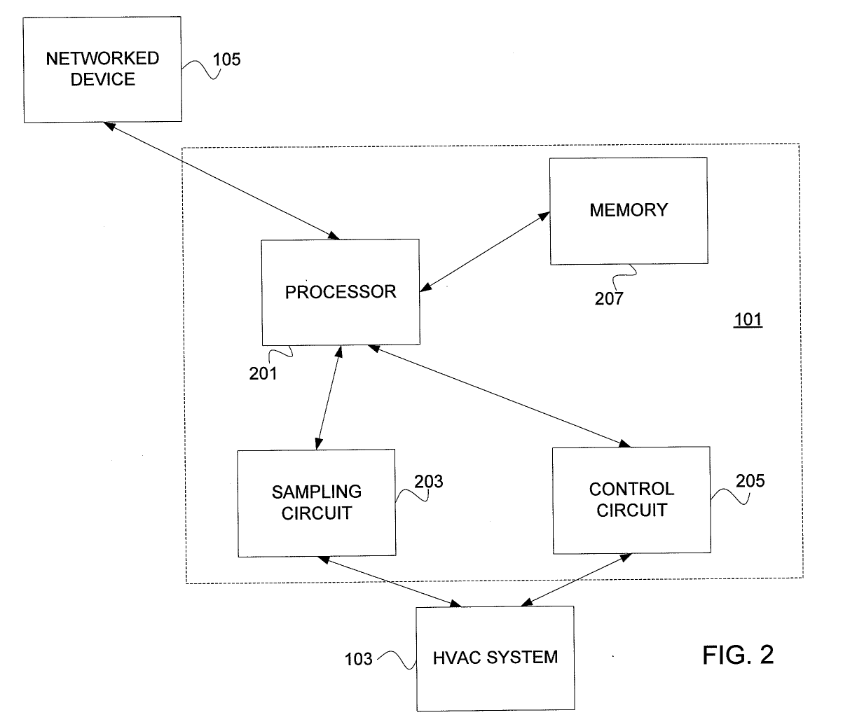

FIG. 2 shows a networking system with a thermostat 101 that determines a type of HVAC system in accordance with an embodiment of the invention. Thermostat 101 includes processor 201, which instructs control circuit 205 to control HVAC system 103 in accordance with configuration data, including the temperature set point. As will be discussed further, processor 201 may instruct sampling circuit 203 to generate a test signal through the connected loads of HVAC system 103 when the loads have been deactivated by control circuit 205.

Embodiments of the invention may include forms of computer-readable media as supported by memory 207. Computer-readable media include any available media that can be accessed by processing circuit 201. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

A thermostat typically selects heating or cooling operation through a switch. In order to reduce the costs, using a switch arrangement can also eliminate a relay. However, a traditional thermostat typically cannot determine the type of HVAC system that the thermostat is connected to.

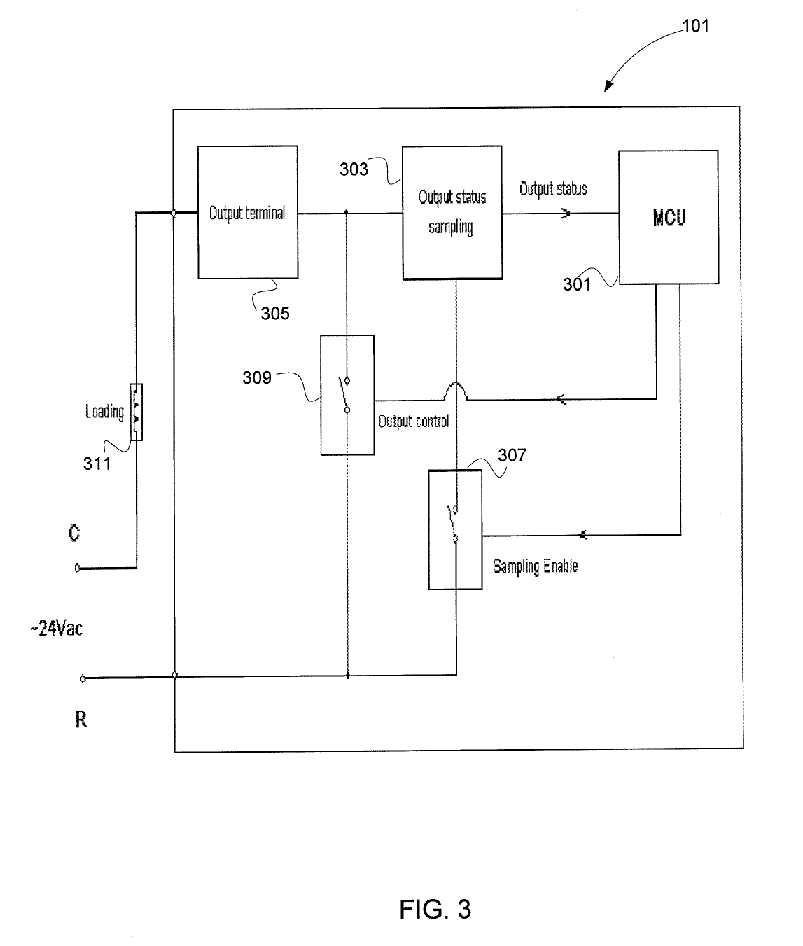

FIG. 3 shows a block diagram for thermostat 101 in accordance with an embodiment of the invention. With some embodiments of the invention, a sensing technique is used to detect the current flow through a switch/relay in order to determine the type of connected HVAC system. FIG. 3 shows the general sensing circuitry block diagram according to an aspect of the invention. External loading 311 can be detected by enabling the sampling enable relay 307, which activates the output status sampling circuitry 303. The output status from sampling circuitry 303 reflects the zero crossing signal of the loading to the Microprocessor (MCU) 301. By detecting different input signal simultaneously or using a multiplexer, the connected HVAC system can be detected automatically.

Processor 301 controls load 311 (which is typically one of plurality of loads contained in HVAC system 103) through output terminal 305 by activating/deactivating switch 309. (Load 311 may correspond to a heat pump reverse valve, cooling reverse valve, second stage heat pump, emergency heat load, fan, or cooling load.) As will be further discussed, processor 301 may instruct sampling circuit 303 to generate a test signal through load 311 by activating switch 307 when switch 309 is deactivated. As will be further discussed, sampling circuit 303 consequently provides a result signal to processor 301 so that processor 301 can determine whether load 311 is connected to output terminal 305.

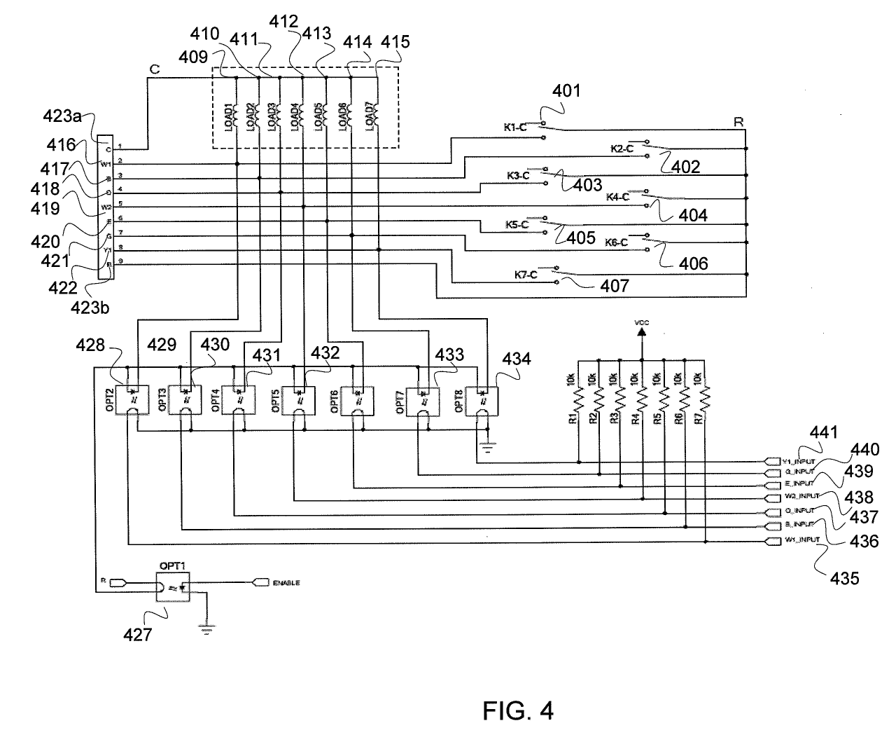

FIG. 4 shows a sampling circuit and control circuit in accordance with an embodiment of the invention. R 423a and C 423b correspond to the 24 VAC input. Each output terminal connects to a corresponding HVAC load 409-415, which is external to thermostat 101 and is typically contained in HVAC system 103. The following control outputs correspond output terminals:

| | |
|---|---|
| B 417: | Heat pump reverse valve |
| O 418: | Cooling reverse valve |
| W2 419: | Second stage heat pump |
| E 420: | Emergency heat |
| G 421: | Fan |
| Y1 422: | Cooling |
| W1 416 | Conventional heat |

With some embodiments, control relays 401-407 are single pole dual contact type relays, where each relay has contact 1 and contact 2. During initialization, all relays 401-407 are reset to contact position 1 (shown in the up position as shown in FIG. 4). Each relay controls HVAC load 409-415, which may or may not be connected to thermostat 101 depending on the HVAC type. Each HVAC load is controlled by a corresponding control relay. For example, control relay 403 controls cooling reverse valve 418.

During normal operation of thermostat 101, OPT1 switch 427 is turned off. Control relays 401-407 are turned on (ON) and off (OFF) according to the differential of measured temperature and set temperature. Whenever a control relay is OFF, detection of the loading connection can be done. Consequently, thermostat 101 can perform real time diagnostics of HVAC system 103. If there is any problem with HVAC system 103 where a load connection is removed, thermostat 101 can detect loss of connection and report the occurrence to a networked device.

When in a control relay is in the up position (contact 1), the corresponding load is deactivated so that a test signal can be inserted into the load. A resulting signal is detected to determine whether the load is connected to thermostat 101. However, when the control switch is in the down position (contact 2), the corresponding load is activated. For example, control relay 421 activates the fan of HVAC system 103 when in the down position. When control relays 401-407 are in down position (i.e., the HVAC loads are activated) thermostat 101 does not inject a test signal into the loads.

By turning on opto-coupler switch (OPT1) 427, current flows into a load if the load is connected. (For example, switch 427 may correspond to Vishay Semiconductors 6N138 optocoupler.) For loads that are externally connected, feedback current is sensed by switches OPT2-OPT7 428-434 because there is zero-crossing signal passing through opto-coupler switches 428-434. (For example, switches 428-434 may correspond to a Hewlett Packard HCPL2730 optocoupler.) Processor 301 can determine the HVAC type from resulting signals 435-441 available at the outputs of switches 428-434. With some embodiments, an output of switches 428-434 is a continuous open or close signal. By detecting the signal, processor 301 can determine whether the HVAC system is connected.

Processor 301 determines the HVAC type from the resulting signals 435-441. When a corresponding load is connected, the corresponding resulting signal is pulled to ground (i.e., the resulting signal voltage is zero) because the corresponding opto-coupler switch conducts current through a resistor to ground. As will be further discussed, processor 301 determines the HVAC type from lookup table 600 by comparing the resulting signal to possible values of the resulting signal.

With embodiments, processor 401 determines the HVAC type by determining what loads are connected to thermostat 101. For the example case, the following is an exemplary mapping of different loads to the HVAC type:

| | |
|---|---|
| W1, G: | Standard Heat Only |
| W1, W2, G: | Standard Heat 2 stage |
| Y1, G: | Standard Cool Only |
| Y1, W1, G: | Standard 1H/1C Non-Heat Pump |
| Y1, W1, W2, G: | Standard 2H/1C Non-Heat Pump |
| Y1, O, B, G, E: | 1H/1C Heat Pump |
| Y1, W2, O, B, G, E: | 2H/1C Heat Pump |

With an aspect of the invention, processor 401 can detect a HVAC system change by periodically injecting a test signal when the HVAC loads are deactivated (i.e., when control relays 401-407 are in the up position). Processor 401 can then send information to a controller (e.g., networked device 105). The controller can consequently perform actions based on the information. For example, if the HVAC system changes from gas furnace to heat pump operation, the networked system can determine to participate in an electricity energy conservation program.

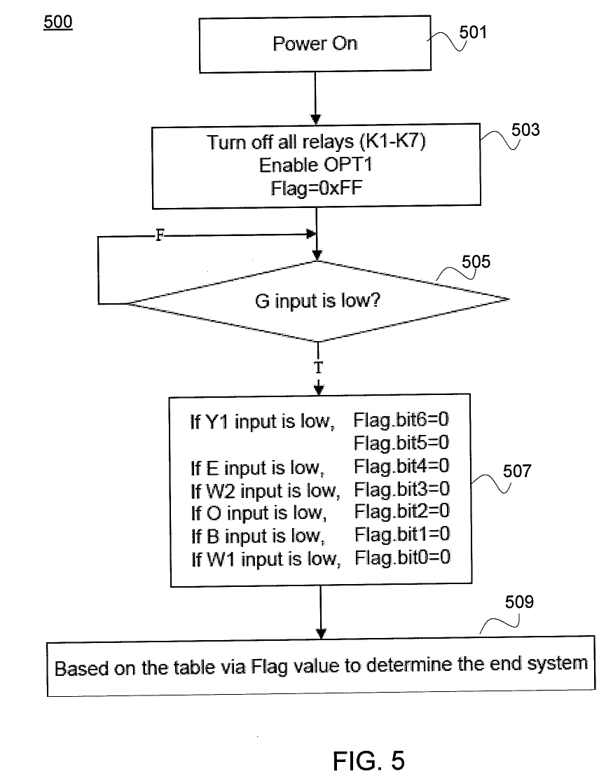

FIG. 5 shows flow diagram 500 for determining the HVAC type in accordance with an embodiment of the invention. In step 501, power is applied to thermostat 101. In step 503, all control relays 401-407 are turned off, and opto-coupler switch 427 is enabled so that a test signal can be injected into the HVAC loads. Processor 401 also sets the flag value to 0×FF. In step 505, processor 401 determines whether the fan load (corresponding to load 414 as shown in FIG. 4). (All of the exemplary valid HVAC types require that HVAC system 103 be configured with a fan.) If a fan is not detected, process 500 loops on step 505 until a fan is detected. With some embodiments, an indicator may be activated to indicate the occurrence of this situation.

In step 507, processor 401 modifies the value of the flag based on the different loads that are connected to thermostat 101. Each detected load results in a corresponding bit in the flag being changed to ‘0’. In step 509, processor 401 utilizes look-up table 600 to determine the HVAC type based on the flag value.

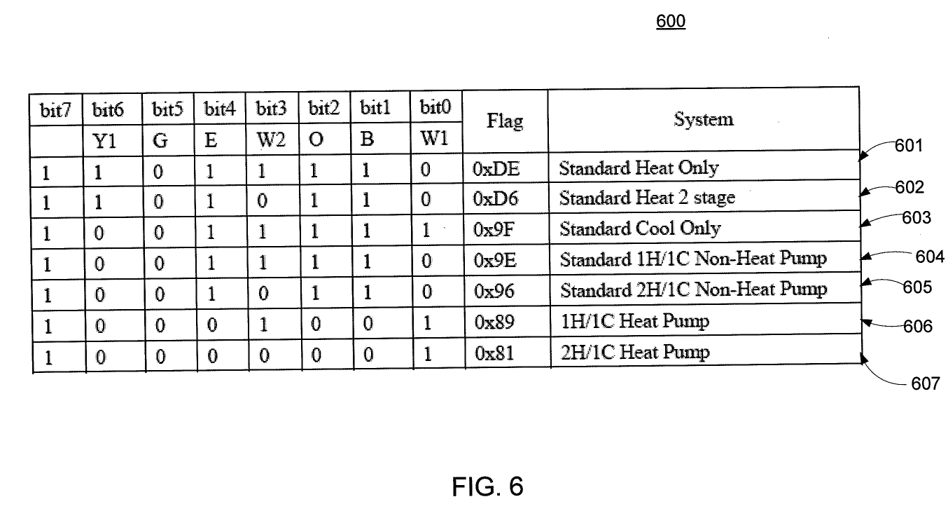

FIG. 6 shows lookup table 600 for determining the HVAC type in accordance with an embodiment of the invention. Look-up table 600 maps HVAC types 601-607 to flag values 0×DE, 0×D6, 0×9F, 0×9E, 0×96, 0×89, and 0×81, respectively. (With the embodiment shown in FIG. 6, bit 7 of the flag is set to ‘1’.) If processor 401 determines that the flag value is not one of the above values, processor 401 may indicate to a user that the HVAC type is invalid. For example, if processor 401 detects only loads W1, O, and G (which is not a valid load configuration in the exemplary embodiment), the corresponding flag value is equal to 0×DA.

As can be appreciated by one skilled in the art, a computer system with an associated computer-readable medium containing instructions for controlling the computer system can be utilized to implement the exemplary embodiments that are disclosed herein. The computer system may include at least one computer such as a microprocessor, digital signal processor, and associated peripheral electronic circuitry.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a control circuit configured to control a first load of a heating, ventilation, and air conditioning (HVAC) system;
a sampling circuit configured to apply a test signal to a first output terminal, wherein the first output terminal corresponds to the first load; and
a processor configured to:
instruct the control circuit to deactivate the first load;
instruct the sampling circuit to apply the test signal to the first output terminal;
determine whether the first load is connected to the first output terminal based on a first resulting signal caused by the test signal; and
determine a HVAC type of the HVAC system based on whether the first load is connected to the first output terminal.

2. The apparatus of claim 1, wherein:
the control circuit is configured to control a second load of the HVAC system;
the sampling circuit is configured to apply the test signal to a second output terminal that corresponds to the second load; and
the processor is further configured to:
instruct the control circuit to deactivate the second load;
instruct the sampling circuit to apply the test signal to the second output terminal;
determine whether the second load is connected to the second output terminal based on a second resulting signal caused by the test signal; and
determine the HVAC type from a load configuration associated with the determined first load and the determined second load.

3. The apparatus of claim 2, further comprising:
a memory containing a lookup table mapping a plurality of load configurations to corresponding HVAC types.

4. The apparatus of claim 2, wherein the processor is further configured to:
send information associated with the load configuration.

5. The apparatus of claim 2, wherein the processor is further configured to:
detect a change of the load configuration.

6. The apparatus of claim 5, wherein the processor is further configured to:
when the change occurs, send configuration information to a networked device.

7. The apparatus of claim 1, wherein the first load corresponds to fan.

8. The apparatus of claim 2, wherein the second load corresponds to one selected from the group consisting of a heat pump reverse valve, a cooling reverse valve, a second stage heat pump, an emergency heat load, and a cooling load.

9 The apparatus of claim 1, wherein the sampling circuit comprises a device configured to sense a zero crossing signal passing through the device.

10. The apparatus of claim 9, wherein the device comprises an opto-coupler.

11. The apparatus of claim 2, wherein the processor is further configured to:
subsequently instruct the sampling circuit to apply the test signal to the first output terminal when a control relay is an off-state.

12. A computer-readable medium having computer-executable instructions that when executed perform:
instructing a control circuit to deactivate a first load of a heating, ventilation, and air conditioning (HVAC) system;
instructing a sampling circuit to apply a test signal to a first output terminal, wherein the first output terminal is associated with the first load;
determining whether the first load is connected to the first output terminal based on a first resulting signal caused by the test signal; and
determining a HVAC type of the HVAC system based on whether the first load is connected to the first output terminal.

13. The computer-readable medium of claim 12, further including computer-executable instructions that when executed perform:
instructing the control circuit to deactivate a second load of the HVAC system;
instructing the sampling circuit to apply the test signal to the second output terminal;
determining whether the second load is connected to the second output terminal based on a second resulting signal caused by the test signal; and
determining the HVAC type from a load configuration associated with the determined first load and the determined second load.

14. The computer-readable medium of claim 13, further including computer-executable instructions that when executed perform:
determining the HVAC type from the load configuration.

15. The computer-readable medium of claim 13, further including computer-executable instructions that when executed perform:
sending information associated with the load configuration.

16. The computer-readable medium of claim 13, further including computer-executable instructions that when executed perform:
detecting a change of the load configuration.

17. The computer-readable medium of claim 16, further including computer-executable instructions that when executed perform:
when the change occurs, sending configuration information to a networked device.

18. The computer-readable medium of claim 13, further including computer-executable instructions that when executed perform:
subsequently instructing the sampling circuit to apply the test signal to the first output terminal when a control relay is an off-state.

19. An apparatus comprising:
a control circuit configured to control a first load of a heating, ventilation, and air conditioning (HVAC) system;
a sampling circuit configured to apply a test signal to a first output terminal, wherein the first output terminal corresponds to the first load; and
a processor configured to:
instruct the control circuit to deactivate the first load;
instruct the sampling circuit to apply the test signal to the first output terminal;
determine whether the first load is connected to the first output terminal based on a first resulting signal caused by the test signal;
determine a load configuration based in whether the first load is connected to the first output terminal; and
determine a HVAC type of the HVAC system from the load configuration.

20. The apparatus of claim 19, further comprising:
a memory containing a lookup table mapping a plurality of load configurations to corresponding HVAC types.

21. The apparatus of claim 19, wherein the processor is further configured to:
send information associated with the load configuration.

22. The apparatus of claim 19, wherein the processor is further configured to:
detect a change of the load configuration.

23. The apparatus of claim 22, wherein the processor is further configured to:
when the change occurs, send configuration information to a networked device.

24. The apparatus of claim 19, wherein the processor is further configured to:
subsequently instruct the sampling circuit to apply the test signal to the first output terminal when a control relay is an off-state.
